(19) United States
(12) Patent Application Publication
(10) Pub. No.: US 2006/0156063 A1
(43) Pub. Date: Jul. 13, 2006

(54) Instant messaging transaction integration

(75) Inventors: Joseph R. Mazzarella, Tolland, CT (US); Jeffrey D. Joyce, Rocky Hill, CT (US)

Correspondence Address: MCDERMOTT WILL & EMERY LLP;ATTN: INTELLECTUAL PROPERTY DEPTARTMENT, 28 STATE STREET, BOSTON, MA, 02109, US

(73) Assignee: Travel Sciences, Inc., Hartford, CT (US)

(21) Appl. No.: 11/312,628

(22) Filed: Dec. 20, 2005

Related U.S. Application Data
(60) Provisional application No. 60/636,874, filed on Dec. 20, 2004.

(51) Int. Cl. G06F 11/00

(52) U.S. Cl. 714/12

(57) ABSTRACT

A system and method are provided that allow an instant messaging (IM) user device to conduct transactions with transaction systems that do not natively allow IM inputs or message processing, wherein an intermediate functionality translates or transforms IM messages from the user device into non-IM communications that can be processed by the transaction system and translates or transform non-IM communications from the transaction system into IM communications for the user device.

### CROSS REFERENCES TO RELATED APPLICATIONS

This application claims the benefit of priority under 35 U.S.C. §119(e) from co-pending, commonly owned U.S. provisional patent application serial No. 60/636,874, entitled EXTENSIBLE APPLICATION USER INTERFACES UTILIZING INSTANT MESSAGING (IMUI), AND EXTENSIBLE TRANSACTION PROCESSING MIDDLEWARE FOR THIRD PARTY SYSTEMS AND USERS VIA AN INSTANT MESSAGING USER INTERFACE EXTENSION. TO MIDDLEWARE SYSTEMS, AND APPLICATION OF IMUI TO TRAVEL RELATED TRANSACTION PROCESSING APPLICATION SESSIONS, filed Dec. 20, 2004.

### FIELD OF INTEREST

The present inventive concepts relate to the field of network computer systems and methods and particularly to systems that are configured for instant messaging.

### BACKGROUND

As is widely appreciated, the provision of goods and services from a wide variety of sources can now be done via the Internet and World Wide Web (or “Web”) with a Web-enabled user device—generally referred to as “e-commerce.” A Web browser application runs on the user's device allows and enables that device to access and interact with the Web sites and pages of a variety of electronic transaction systems. To transact business with such sites, a user enters information necessary or useful in completing the transaction. The Web site may include various devices for navigating through the site to find or learn about products or services. The Web site will typically also include defined fields requiring user input for transaction information, which could include the user's name, address, telephone number and e-mail address. Such information may also include payment information, such as credit card information. Once the transaction system has received all required transaction information, the transaction can be processed and completed. Confirmations may be presented through a Web page, e-mailed to the user, or both.

In parallel, another Internet related technology has come into wide usage—instant messaging (IM). IM allows users to engage in real-time text dialogue without the need for creating, addressing and sending e-mail. While IM may be provided through, or in connection with, an e-mail program application, it is quite different from e-mail. In fact, IM may also be provided through cell phones and personal digital assistants. The benefit of IM it is conversational: a first user types in a text line and then sends it. The recipient receives the IM text at its device and responds with her own text message. The dialog goes back and forth, much like a typical conversation.

While e-commerce and IM have steadily grown, to date there has been no apparent motivation to integrate the two. As a result, users conducting transactions on the Web are left with a rigid Web pages based approach, without the more natural style of IM.

### SUMMARY OF INVENTION

In accordance with one aspect of the disclosure, an instant messaging-transaction integration system is configured to interface with at least one user device and transaction processor, the at least one user device configured to communicate using instant messaging (IM) and the at least one transaction processor configured to conduct a transaction using a set of transaction instructions and data and to generate a set of requests to obtain the set of transaction instructions and data. The system comprises an integration module configured to generate IM messages configured for processing by the user device that solicit IM responses comprising transaction information useful in satisfying a set of requests by the transaction processor, the integration module also configured to generate from the IM responses user transaction instructions and data configured for processing by the transaction processor to satisfy the set of requests.

In accordance with another aspect of the disclosure, an instant messaging transaction integration system comprises a variety of devices configured to communicate over a variety of types of networks. The system may comprise or interface with a user device configured to communicate using instant messaging (IM) and a transaction system configured to conduct a transaction using a set of transaction instructions and data and configured to generate a set of requests to obtain the set of transaction instructions and data. An integration module is include and may be configured to generate IM messages configured for processing by the user device that solicit IM responses comprising transaction information useful in satisfying a set of requests by the transaction processor, the integration module also configured to generate from the IM responses user transaction instructions and data configured for processing by the transaction processor to satisfy the set of requests.

In accordance with another aspect of the disclosure, a method of conducting an electronic transaction using instant messaging is provided. The method may comprise interfacing to a user device configured to communicate using instant messaging (IM) and interfacing to a transaction processor configured to conduct a transaction over a network in response to receipt of a set of transaction instructions and data and to generate a set of requests for the set of transaction instructions and data. The method may further comprise generating IM messages configured for processing by the user device that solicit IM responses comprising transaction information useful in satisfying a set of requests by the transaction processor. From the transaction information in the IM responses, the method may also include generating user transaction instructions and data configured for processing by the transaction processor to satisfy the set of requests.

In accordance with another aspect of the disclosure, a computer program product for conducting an electronic transaction using instant messaging is provided. The computer program product is embodied in a program code configured to be stored on at least one storage media and executed by at least one processor. The program code may comprise a program code configured for interfacing to a user device configured to communicate using instant messaging (IM) and a program code configured for interfacing to a transaction processor configured to conduct a transaction over a network in response to receipt of a set of transaction instructions and data and to generate a set of requests for the set of transaction instructions and data. The program code may further comprise a program code configured for generating IM messages configured for processing by the user device that solicit IM responses comprising transaction information useful in satisfying a set of requests by the transaction processor. And the program code may comprise a program code configured for generating, from the transaction information in the IM responses, user transaction instructions and data configured for processing by the transaction processor to satisfy the set of requests.

In accordance with another aspect of the disclosure, an instant messaging-transaction integration system is provided and configured to interface with at least one user device and at least on electronic reservation processor. The user device(s) is configured to communicate using instant messaging (IM) and the electronic reservation processor(s) is configured to conduct reservation-related transactions using a set of transaction instructions and data and to generate a set of requests to obtain the set of transaction instructions and data. The system may comprise an integration module configured to generate IM messages configured for processing by the user device that solicit IM responses comprising transaction information useful in satisfying a set of requests by the transaction processor, the integration module may also be configured to generate from the IM responses, and provide to the electronic reservation system(s), a set of user transaction instructions and data incorporating the transaction information, such transaction instructions and data formatted for processing by the electronic reservation processor to satisfy the set of requests.

In accordance with yet another aspect of the present disclosure, a method of conducting an electronic reservation transaction using instant messaging is provided. The method may comprise interfacing to a user device configured to communicate using instant messaging (IM) and interfacing to an electronic reservation processor configured to conduct an electronic reservation transaction over a network in response to receipt of a set of transaction instructions and data and to generate a set of requests for the set of transaction instructions and data. The method may also comprise generating IM messages configured for processing by the user device that solicit IM responses comprising transaction information useful in satisfying a set of requests by the electronic reservation processor and from the transaction information in the IM responses, generating user transaction instructions and data in a format configured for processing by the electronic reservation processor to satisfy the set of requests.

### BRIEF DESCRIPTION OF THE DRAWINGS

The drawing figures depict preferred embodiments by way of example, not by way of limitations. In the figures, like reference numerals refer to the same or similar elements.

FIG. 1A and FIG. 1B are block diagrams showing aspects of two embodiments of an IM-transaction integration system, in accordance with the present invention.

FIG. 2 is a representative flowchart showing a method that may be implemented by the system of FIG. 1 or FIG. 1B.

FIG. 3 is a block diagram of one embodiment of the system of FIG. 1B.

FIG. 4 is a block diagram of a different embodiment of the system of FIG. 1A.

FIG. 5 is a block diagram of an IM-transaction integration system implementation wherein the transaction system is one or more electronic reservation systems.

### DETAILED DESCRIPTION OF PREFERRED EMBODIMENT

A system and method are described that allow a user device to conduct typical e-commerce transactions using instant messaging (IM) technology, including the communication of text messages. Various aspects of the present invention can take any of a variety of embodiments, including, but not limited to, those embodiments described herein. In various embodiments, a set IM-transaction integration functionality may be disposed between an IM enabled user device and the functionality of a transaction system. In one embodiment, the IM-transaction integration functionality may be hosted as “middleware” on a system disposed between a user device and a transaction system, which may be a network-enabled (e.g., Internet or Web-enabled) transaction system. In other embodiments the IM-transaction integration functionality may be disposed at the user device, transaction system, or some combination thereof. In the various embodiments, the transaction system may be comprised of one or more physically diverse locations containing one or parts or elements, or sub components thereof, described below, that are under the control, common control, or coordinated operation or use of one person or two or more related or unrelated parties acting in concert. The functionality described herein may be implemented in hardware, software, firmware or some combination thereof.

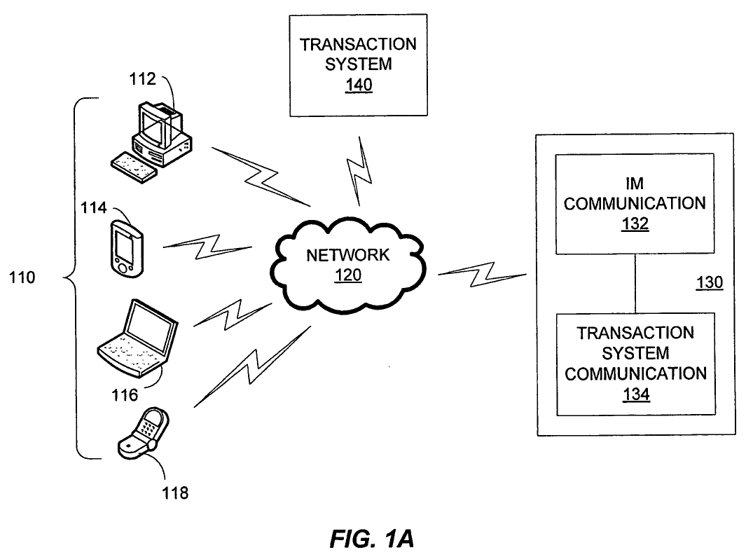

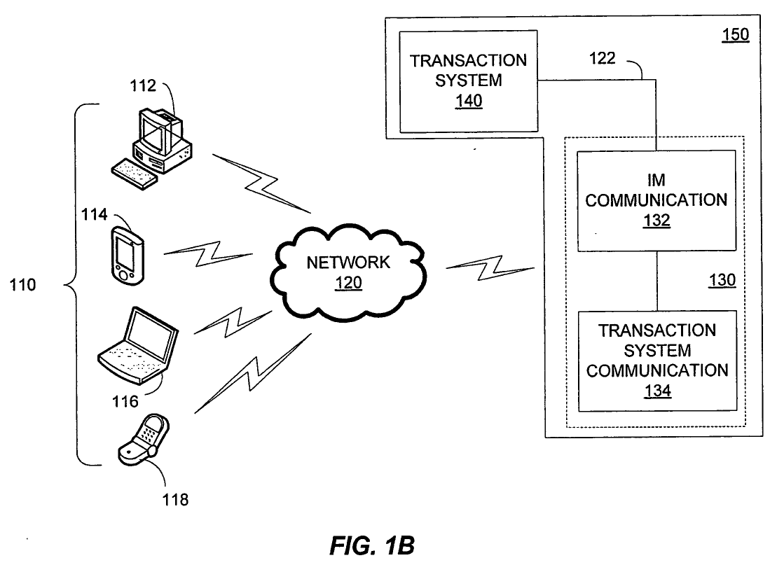

FIG. 1A and FIG. 1B are block diagrams of two embodiments of systems that may be used to implement a set of IM-transaction integration functionality. A user device may take any of a variety of forms, so long as it is configured for instant messaging in any commonly known or later developed forms. In FIG. 1A such user devices are represented as a group 110 of typical user devices configured for IM, including a personal computer (PC) 112, personal digital assistant (PDA) 104, laptop computer 106 or cellular telephone 108. These are provided as examples and not intended as an exhaustive list of such devices. Any other device capable of IM could be used.

In this embodiment, the user devices 110 do not include any special functionality, but are merely configured with typical IM capability, which is often found in such devices through applications such as e-mail programs. For example, IM protocols from AOL, MSN and ICQ are a few presently common IM applications implementing known IM protocols. The user devices 110 communicate with a set of IM-transaction integration functionality via at least one network, represented by network cloud 120. The network 120 may be comprised of one or more of the Internet, Worldwide Web (or “Web”), intranet, extranet, virtual private network (VPN), telephony networks and so on, any of which may include any combination of wired or wireless transmission paths.

The IM-transaction integration functionality may be hosted by an IM-transaction integration system 130 comprising typical processors and storage devices, as in FIGS. 1A, 1B, 3 and 4. Ultimately, the IM-transaction integration functionality allows a user device 110 to engage in transactions with one or more transaction systems 140, where the user device communicates using IM and the transaction system does not directly engage in or process transactions using IM. The transaction systems represented by transaction system 140 may be any type of on-line or e-commerce system that enables the provisions of goods or services. For example, such systems may include, but are not limited to, systems for making travel arrangements, such as transportation, hotel and related service, for example, as provided by Orbitz, Travelocity and American Airlines. Transaction systems may also be typical systems for on-line shopping, such as provided by e-Bay, Amazon, and LL Bean. The examples are too numerous to list.

Typical transaction systems 140 of these types usually engage in transactions by prompting a user to enter transaction information through user interaction with structured Web page display mechanisms, such as selecting among predetermined choices presented in a Web page rendered on a computer screen (e.g., lists, menus, buttons, or icons), entering alphanumeric information into predefined fields (e.g., name, shipping address, e-mail address, credit card information), or some combination thereof. This type of interaction does not allow a natural “conversation” between the user and transaction system, such as the two-way dialog offered through IM. As shown in FIG. 1A, an IM-transaction integration system 130 could be a standalone system, configured to remotely access, or be remotely accessed by, user device 110 and the transaction system 140. But in other embodiments, as shown in the embodiment of FIG. 1B, transaction system 140 may integral with or local to the IM-transaction integration system 130, to form a combined system 150, wherein a direct or local connection between the two may be represented by link 122. In this case, transaction system 140 and IM-transaction integration system 130 could reside on separate servers (locally networked) or within the same server or servers. In other embodiments, components of the IM-transaction integration system 130 could be loaded on the user device 110 for use during an IM-transaction session.

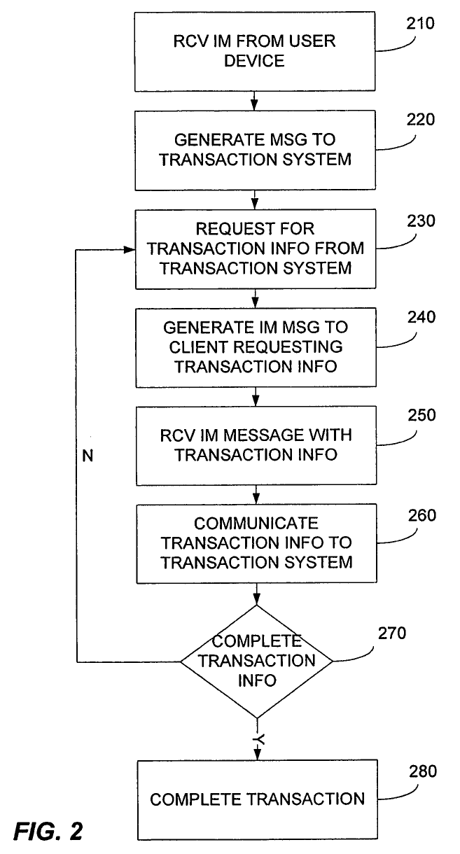

FIG. 2 provides a representative flowchart showing an IM-transaction integration method that may be implemented by the IM-transaction integration system of FIG. 1A or FIG. 1B. In step 210 the IM-transaction integration system receives an IM message (e.g., a text message) from a user device 110 requesting information related to a possible transaction. The IM-transaction integration system interprets the received IM message and generates a message to the transaction system 140, in step 220. As will be discussed in greater detail below, the IM-transaction integration system may parse the text of the received message to determine transaction related information needed to communicate with the transaction system to facilitate an IM-transaction session. For instance, if the user could enter an IM text message that indicates he wants to travel, e.g., “I did like to arrange some flights.” The IM-transaction integration system could parse that phrase to determine that the user needs to arrange travel through an airline or travel agent. Numerous programs and approaches for parsing text are generally known in the art and could be used, so are not discussed in detail herein.

The session may be initiated in any of a variety of manners. For example, it could be user initiated (as discussed above), it could be initiated by the transaction system 140, or it could be initiated by a third party system that facilitates such transactions. Regardless, in step 230 IM-transaction integration system 130 receives a request for transaction information. Transaction information can be any information, data or instructions that are useful or necessary in facilitating, enabling, or completing a transaction. For example, transaction information could include a name, address, telephone number, and/or product or service of interest. In the case of a travel transaction, the transaction information could include destination, number of travelers, flight preferences, accommodation preferences, passport information, dates of travel, credit card information and so forth.

A request for transaction information needed by the transaction system 140 may be generated by the transaction system or it may be derived from the transaction system Web pages. In step 240, given a request for transaction information from the transaction system 140, the IM-transaction integration system 130 generates an IM message requesting such transaction information, which is then transmitted to the user device 110. The substantive content of the IM message, i.e., that soliciting transaction information, may be derived from the prompts, lists, menus, buttons, or icons or fields embedded in the web pages of the transaction system Web site, as examples. These may be determined through analysis of the code (e.g., HTML) that makes up such Web pages. The IM messages generated by the IM-transaction integration system 130 may be fully or partially scripted in advance and stored in memory, and then recalled or generated as appropriate. In such a case, the scripts could be tailored for one or more transactions systems. For example, the IM-transaction integration system could be configured as a front end to a specific transaction system of optional interface available through the transaction system Web site.

Returning to FIG. 2, in step 250, in response to the request for transaction information, an IM response from the user device 110 is received by the IM-transaction integration system 130. The IM-transaction integration system 130 parses the response to determine the transaction information and then, in step 260, communicates the transaction information to the transaction system 140, which may include interacting with the Web pages of the transaction system, as mentioned above. In step 270, if the transaction system 140 has received all of the required transaction information, the transaction (and session) may be completed, in step 280. However, if further information is needed or desired, the process may continue to step 230 where the transaction system requests further transaction information. It will be appreciated by those skilled in the art that several IM messages could be exchanged between the IM-transaction integration system 130 and user device 110, before the IM-transaction integration system subsequently communicates with the transaction system 140. It will also be appreciated that IM messages may be generated to suggest complimentary products or services to those originally sought by the user, which could lead to a new transaction oriented IM session with a different or the same transaction system.

As discussed above, in various embodiments the IM-transaction integration system 130 may be configured to provide an extensible (or client side) application program interface (API) that enables a user of an IM-enabled device 110 to either initiate an IM session to the transaction system 140 (referred to at times herein as a “Host” or “host”) or respond to an IM session initiated by the transaction system 140, as discussed above with respect to FIG. 2. The user device 110 communicates with the transaction system 140 to submit, via the IM session and utilizing the applicable IM protocol, text based, hypertext linked, or other visual or voice aided active objects, executable and/or other client-side control, commands and instructions to transaction-related software applications residing and/or operating on one or more server or servers, or other computing devices, that initiate and/or execute transaction-related functions or routines, processes or procedures. Through this IM session, the user device 110 may also receive transaction-related application generated output, such as information responses and requests, in IM form, from the transaction system 140.

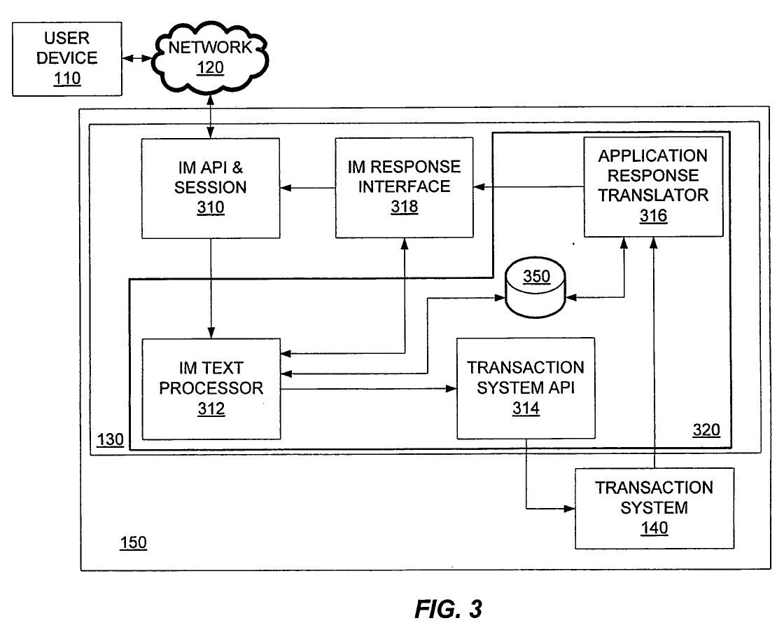

In the block diagram example of FIG. 3, an embodiment of a combined system 150, such as that shown in FIG. 1B, is shown. The combined system 150 comprises the IM-transaction integration system 130 and transaction system 140. In such a case the IM transaction integration system could serve as part of the front end of the transaction system 140. The IM-transaction integration system 130 includes a set of modules that can be configured to implement the functionality of the IM communication module 132 and transaction system communication module 134 of FIG. 1A and FIG. 1B, including a set of modules that may be referred to as middleware 320. These modules provide the core of the internal processing of the IM-transaction integration system 130. In this embodiment, the IM-transaction integration system 130 includes an IM API and session management module 310 that manages the communication with the user device 110, and provides general management of the IM session (e.g., initiation, maintenance, and termination). As such, the IM API & session management module 310 is configured to establish an IM session between the IM-transaction integration system 130 and the user device 110, and maintain it until the transaction is completed. Once an IM message is received by the IM API & session module 310, it is processed by the IM processing module 312. The IM processing module 312 identifies the content of the IM text and derives transaction information therefrom. This may include parsing the IM text or otherwise searching the text for keywords (i.e., words having predetermined meaning or serving as flags for needed transaction information). The keywords may be stored in one or more databases, such as database 350.

To the extent transaction information (including instructions and data) is found in the IM text, it may be provided from the IM processing module 312 to the transaction system 140, via a transaction system API module 314. Such information can be provided to satisfy the Web pages inputs or selections of the transaction system 140. The transaction system API module 314 integrates the transaction information into messages or inputs to the transaction system in a format (or in accordance with a protocol) known acceptable by the transaction system 140. The formats of typical Web page inputs are known in the art, so not discussed in detail herein, as in the parsing of Web pages to determine required input fields that can be automatically filled without direct user entry. Additionally, or alternatively, the IM processing module 312 may cause the IM response module 318 to generate an IM message for transmission to the user device, such as a request for further information or a confirmation of information received.

Whether in response to receipt of transaction information or a transaction related query from the transaction system API 314, or otherwise, if the transaction system 140 requires information from the user device a message is sent to an application response translator 316. The application response translator 316 determines the subject matter of the request and generates, derives or selects elements of an IM message to be sent to the user device 110. This may be accomplished by generating or acquiring from database 350 scripts, data, information, or logic useful in generating an IM response. The application response translator 316 passes the content needed for the desired IM message to an IM response interface 318, which generates the IM message for communication to the user device 110, via the IM API & session application 310.

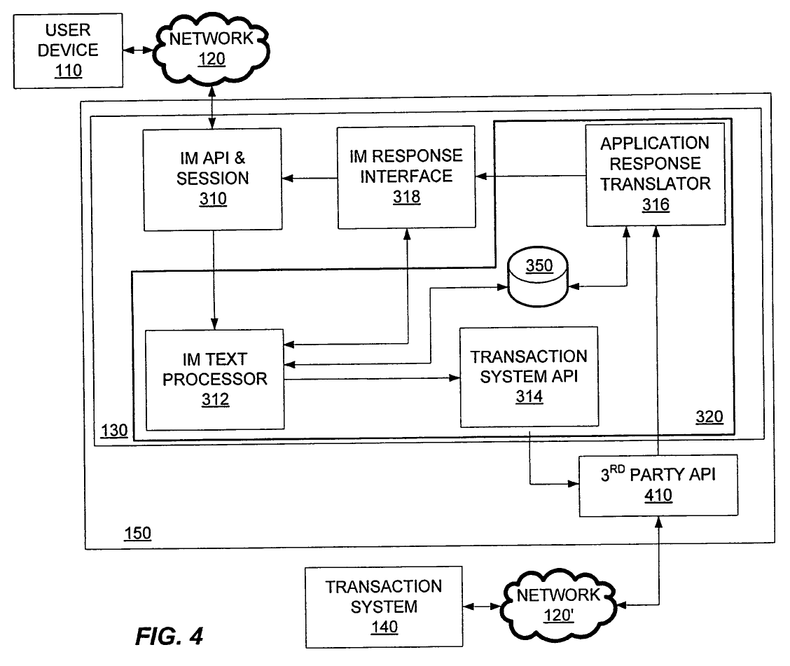

The IM-transaction integration system 130 may also be implemented as a primarily intermediate application (e.g., middleware), between the user device 110 and a third party transaction system, such as transaction system 140, as shown in FIG. 1A and FIG. 4. As discussed above, generally, the IM-transaction integration system 130 is comprised of one or more software applications operating on one or more computing devices that enables electronic data exchange and the submission of commands and instructions between the IM-transaction integration system 130 and other third party electronic computing systems, such as transaction system 140.

The embodiment of FIG. 4 includes several modules similar to those of FIG. 3, but in FIG. 4 the transaction system 140 is accessed via a network 120′, which may be the same as network 120. The transaction system 140 is not local to or integral with IM-transaction integration system 130 in this embodiment. In such a case, the IM-transaction integration system 130 may include the IM API & session module 310, which provides an interface between the middleware layer 320 and the user device 110. Communications of the remote systems 110, 130, and 140 may take place via one or more communications and data transmission paths 120 and/or 120′ and protocols. The communication network 120 enables the submission of commands and instructions that originate via an IM based message submission from user device 110 to the middleware layer application 320. Middleware layer 320, in turn, through translation and/or transformation of such submissions and data by the IM test processor 312, transaction system API 314 and 3rd party API 410, submits such user instructions and commands to the transaction (or third party) system 140, via network 120.′

Transaction information requests and related information and data responses to the user's IM message are received by the IM transaction integration system 130 and from the transaction system 140 are received via network 120′and 3rd party API 410. The application response translator 316 processes such information and data (e.g., translation or transformation) to generate an IM response to the user device 110, which is formatted by IM response interface 318 and ultimately transmitted via IM API & session module 310 to user device 110, as discussed above. Thus an end-to-end extensible user interface is provided that enables applications and computing systems of one or more third parties to be accessed, used and/or controlled through messages generated from an IM session.

Without limiting the scope of the general concept and all uses and applications which may arise therefrom, the following examples of applications of the concepts disclosed herein and methods for implementing same are provided. In one embodiment, the present concept enables users accessing an IM session via the Internet and one or more instant messaging protocols, such as AOL, MSN, ICQ or other formats, to conduct communication sessions over Internet based communication links that enable the user to search, book and/or reserve and/or settle the payment for the purchase of travel related products, including hotel reservations, airline tickets, car rentals, restaurant reservations, golf reservations, and other related items. In such an embodiment, the transaction system 140 may include one or more electronic reservation systems for providing the foregoing. The present disclosure uses IM as the means through which a user can access and communicate with one or more electronic reservation systems, including global distribution systems ('GDS”), such as those provided by Sabre, Amadeus, Worldspan, Galileo, Pegasus and or other providers of search and booking and reservation systems, including Web based or online reservation providers, such as, but not limited to, Travelocity and Orbitz. IM messages between the user and a transaction system, via the IM-transaction integration functionality, enable the user to search for product or service availability, make reservations of available products, and to make electronic guarantees or payments for such product, and to receive back confirmations of such reservations and/or purchase. Such communication may embody, therefore, reservation related requests, responses, commands, instructions and data.

In certain embodiment of the invention, the response and communications messaging that is generated by the IM-transaction integration system is in response to a user initiated session or message. The IM-transaction integration system responses may be scripted responses that are generated from a software based program, such as the middle ware discussed above. These IM-transaction integration system generated messages may include instructions and information responses based upon the user's messages that were initially sent to the IM-transaction integration system. In addition to generating scripted responses, in response to a user's message the IM-transaction integration system may also, as and when necessary based upon the user's response and/or the software logic of the middleware layer, either, directly or indirectly, send formatted messages and commands to the reservation system (or transaction system) that enable the reservations system to execute various requested functions. Responses from the reservations system are then received by the IM-transaction integration system, and then are made available, either natively or in a transformed manner, to the IM user via a message sent via the IM-transaction integration system.

In certain embodiments, the IM-transaction integration system uses IM communication (which are typically used for basic person-to-person text messaging) for e-commerce transaction processing within a commercial market sector that has yet to apply IM for such purposes, other than in the context of customer relationship management (CRM) contexts. In these contexts static information and data is accessed, and predetermined profile information fields are updated. An embodiment of the IM-transaction integration system uses the IM messaging construct as the user interface (UI) through which real-time electronic commerce transactions can be initiated and completed by the User, and the middleware layer or intermediary, translates and/as applicable transforms messages to conform to the messaging and command formats of the reservation systems using one or more differing interface protocols, including XML, HTML, EDI and proprietary application programming interfaces (APIs).

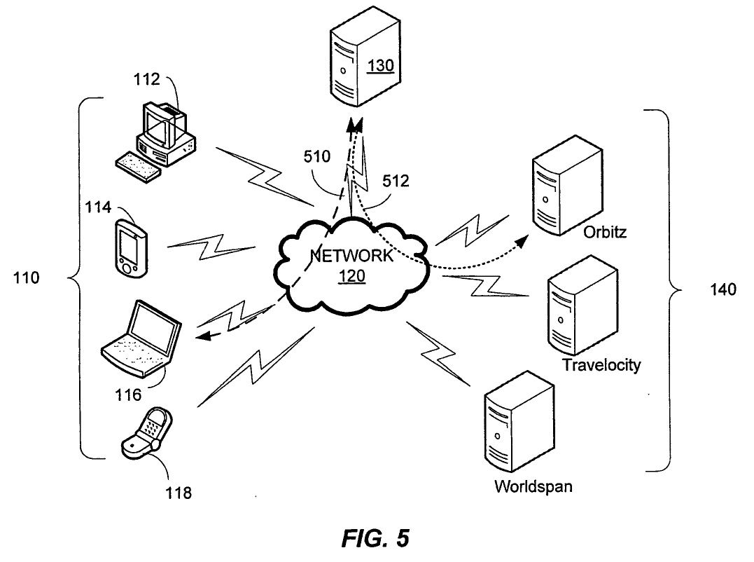

FIG. 5 is a block diagram of an IM-transaction integration system 130 used in the context of one or more electronic travel reservation systems 140. In FIG. 5, such systems may include Worldspan, Travelocity and Orbitz. The IM-transaction integration system 130 is setup as middleware and accessible over network 120, as are the electronic reservation systems 140. Regardless of the physical orientation of the IM-transaction integration system 130 and electronic reservation systems 140, the IM-transaction integration system 130 functionality could be made directly accessible to a user device, e.g., device 116, or made available via an electronic reservation system 140.

Example of a communication session between the user device 116 and the IM-transaction integration system is provided below. The IM-transaction integration system 130 and user device 16 engage in IM communication indicated by dashed line 510. And the IM-transaction integration system 130 and Orbitz electronic reservation (or transaction) system using communication formats and protocols native to the electronic reservation system, as discussed above with respect to FIG. 4, for example. The IM-transaction integration system 130 is the responding system in this example, and messaging and data responses that include data and messages that are native to the IM-transaction integration system 130 and those that are derived from a third party reservation system 140 are embodied in the IM messages from “AIRIM” while the user device 16 messages are indicates as belonging to “Joe.”

AIRIM: Hi, what is your name?

Joe: Joe

AIRIM: Ok. Joe, where do want to fly to?

Joe: Las Vegas

AIRIM: O.k., to Las Vegas, Nev. (MCR). Where are u leaving from?

Joe: BDL

AIRIM: O.K., from Hartford, Conn. (BDL) to Las Vegas, Nev. (MCR). Is this a 1 Way or Roundtrip?

Joe: R

AIRIM: What date are u leaving? (click here if you need a calendar)

Joe: Dec. 26, 2004

AIRIM: When are u returning?

Joe: Dec. 28, 2004

AIRIM: How many adult passengers?

Joe: 4

AIRIM: Any kids?

Joe: No

AIRIM: Do you want Economy class, First class or Any

Joe: E

AIRIM: How many flight connections are OK with you None, 1, 2?

Joe: 1

AIRIM: Do you need any special assistance? (Yes or No)

Joe: No

AIRIM: Ok, hang on I'll check available flights for you . . . this may take a second or two . . . I found 50 flights. Here are the first 10 from lowest price to highest price. If U like one then give me the item number. If you want More Options or if you want a New Search just tell me:
1. $155.00 per seat—American—Connections: 1 in Dallas—Leave 7:03 AM—, Arrive 11:00 AM—Non Refundable
2. $198.00 per seat—Delta Connections: 2 in Baltimore and Phoenix—Leave 8:00 AM and Arrive 8:00 PM—Non Refundable

Joe: 2

AIRIM: O.K., thanks. That's Delta Flight # 234—Hartford to Las Vegas, Depart December 26 at 7:00 AM and Returning December 28 on Delta Flight # 657, Departing 9:00 PM. Should I book 4 seats for you? (Yes or No)

Joe: Yes

AIRIM: Excellent, please give me your first and last name.

Joe: Joe Mazzarella.

AIRIM: O.K., please give me you home address (example: 12 Any Street, Hartford, Conn. 06084).

Joe: 110 Doyle Road, Tolland, Conn. 06084

AIRIM: O.K., please give me the phone number where I can reach you and include your area code.

Joe: 860-870-7977

AIRIM: O.K., can you give me an e-mail address where I can send your confirmation and ticket info?

Joe: mazz@cttel.net

AIRIM: O.K., great. Can you give me the other travelers first and last names—you can separate them by a comma (i.e., John Doe, Harry Smith).

Joe: Wendy Mazzarella, Gaby Mazzarella, Mary Mazzarella

AIRIM: Thanks, you're almost all set. Do you want me to find a Hotel or Car or both in Las Vegas? (Otherwise say “No”)

Joe: No

AIRIM: O.K., that's fine. If you change your mind, you can IM me later. I need your credit card payment info. Just so you know, this is a secure, encrypted communications session, and your private information is protected.

AIRIM: Can you give me your credit card type (Amex, Visa, Discover, Master Card).

Joe: V

AIRIM: Thanks. Please give me the card number:

Joe: 24354647478484994

AIRIM: Thanks. Please give me the expiration date (i.e., January 2007).

Joe: March 2006

AIRIM: Thanks. On the back there is a 3 or 4 digit security code (on front for Amex), can you give it to me?

Joe: 3033

AIRIM: Great. That's all I need. The Total Amount including taxes is $2,300.57. Tell me what to do:
1. “Yes” to confirm your purchase.
2. “No”, if you want to quit or start all over.
3. “Invoice Check” If you want to review the purchase breakdown.
4. “Rule Check” if you want to review the ticket rules and restrictions.

Joe: Yes

AIRIM: Hang on while I process your payment . . . this could take a minute. Congratulations! You are all done. A copy of your Itinerary has been emailed to you. Here is a summary of your purchase . . . .

As one skilled in the art will appreciate, the following descriptions represent exemplary aspects of the present disclosure that may be implemented singularly or in various combinations with other aspects described herein:

1. Using embedded HTML links and active images to enable the user to initiate a browser based session, or other operating system or executable function or series of functions by the user's communications and computing device, for purposes of accessing additional information and data content. Such content may include visual or graphical content, including pictures and images, and audio content, including real time voice response. Such additional content may be provided through a user request or offered on a contextual basis from the IM-transaction integration system based on a series of one or more user instructions or patterns of message submissions, or are offered from a third party system as a result of instructions, queries or other information or data that is exchanged between the middleware layer and third party system.

2. Processing structured or interpreting unstructured text message based commands or instructions that are generated by the user's IM communication and sent to the IM-transaction integration system to initiate and execute defined functions either within the IM-transaction integration system environment and or with external third party applications or reservations systems.

3. Using a convention of providing text-based instructions to the user soliciting keyword responses that, when input and sent by the user to the IM-transaction integration system, are recognized, or interpreted, and or translated, using a translation table of keywords or other software based algorithm for identifying keywords in text, including parsing the IM text to locate keywords. The keywords correspond to command or data submissions that are formatted to be received and processed by either the IM-transaction integration system or, for providing transaction information, or otherwise enabling a transaction, with a transaction system, such as a third party electronic reservation system.

4. Utilizing, establishing, imposing and/or applying an order and precedence logic of the IM-transaction integration system, and/or middleware that is communicating with a transaction system, as the basis and means for determining, formulating and sending a structured communication response with application (or transaction) related or middleware related instructions to the user via IM.

5. Utilizing one or more databases together with functions that are executed to determine the likely meaning or user intent from responses received from the user, where the response does not conform with previously sent instructions, or otherwise in the absence of sent instructions to the user. The functionality may be implemented by including: (1) parsing text strings and data submissions to identify one or more characters that have strings similar to those existing within translation databases (such as database 350 described above in FIG. 3). The translation databases may contain one-to-one, one-to-many, or many-to-many associations between text or other command lists and their associated application instructions and data submissions that may be processed by the IM-transaction integration system (or middleware); and (2) employing spelling checker algorithms and computer programs (such as those known in the art) that, when a response is not understood or expected by the IM-transaction integration system based upon instructions sent to the user. Or in the absence thereof, the spell checker may generate proxy response alternatives and compare such proxy response alternatives to the logically expected commands or responses, and any other available commands or inputs that are stored in the translation database environment. And based upon order and precedence schemas that relate to the IM-transaction integration system application or middleware layer, either process the selected proxy response, or, using one or more algorithms that determine relevance, reject the proxy response and use other interpretation routines or methods. If no proxy can be determined, or determined with confidence, the IM-transaction integration system can send an IM “Did you mean . . . ” response back to the user with the likely proxy alternative and seek a confirmation response from the user. And: (3) establishing alternative word and character submissions equivalents that are relationally associated with submission word or information response instructions within or associated with the translation database, such as, but not limited to, the following examples: text string “Next” from IM submission response equals “Next Page” for the IM-transaction integration system application; and “N” and “Nxt” may also equal “Next” for text string responses from the IM submission. And: (4) using language translation software and computer programs that allow for multi-lingual IM-based user application interfaces that, utilizing, translation tables or other algorithms, establish equivalency to enable more than one language to be used and/or associated with the command translation databases described above.

6. Utilizing data and communications encryption technologies, either through pre-existing security and encryption embedded in proprietary IM protocols or other Internet Protocol security and/or encryption based technologies, to enable secure communications transmissions between the user and the IM-transaction integration system. Such security could be implemented for the entire session or for parts thereof, such as for credit card or other forms of payment, financial or other personal or private information, and utilizing the IM-transaction integration system application or middleware order and precedence. Or based upon their respective states, requiring or indicating a secure transaction state, transitioning to a secure or encrypted transmission environment or state to secure private or secure information and data exchange events at the IM communications layer.

7. Utilizing the IM protocol and session information, determining the user's IM enabled equipment and/or host operating system or program, and/or screen size, to determine structuring and amount of information that should be returned in any one or more responses from the IM-transaction integration system. This type of information may be determined by means known in the art.

8. Using paged returns and/or other information content division or allocation methods at IM-transaction integration system to structure information search results and returns that are derived from a user initiated query command, and using text based paging commands, including page number instructions, alphabetical letter or other similar hierarchical or series based schemas, or sorting and/or filtering, to enable the user to navigate to other pages of a returned list of information or options communicated by the IM-transaction integration system. Using a session in memory or utilizing temporary tables at the application level to cache results that are generated in response to a user query or instruction which are to be paged or otherwise allocated and returned upon the request of the user.

9. In an electronic reservation system (as the transaction system) context, generating booking transaction message confirmations that are sent upon completion of a booking and payment transaction or booking with a payment guarantee transaction and transmitting the confirmation to the user via the IM session, and also simultaneously, or thereafter, sending the conformation message and data, either in its native form or in a transformed form, to an e-mail address, facsimile or other content transmission device, system and address selected or instructed by the user.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. As used herein, the terms “includes” and “including” mean without limitation. It is intended by the following claims to claim any and all modifications and variations that fall within the true scope of the inventive concepts.

What is claimed is:

1. An instant messaging-transaction integration system configured to interface with at least one user device and transaction processor, the at least one user device configured to communicate using instant messaging (IM) and the at least one transaction processor configured to conduct a transaction using a set of transaction instructions and data and to generate a set of requests to obtain the set of transaction instructions and data, the system comprising:
A. an integration module configured to generate IM messages configured for processing by the user device that solicit IM responses comprising transaction information useful in satisfying a set of requests by the transaction processor, the integration module also configured to generate from the IM responses user transaction instructions and data configured for processing by the transaction processor to satisfy the set of requests.

2. A system as in claim 1, wherein the transaction processor comprises one or more electronic reservation systems.

3. A system as in claim 1, wherein the integration module and transaction processor are integrated into a combined system.

4. A system as in claim 1, wherein the integration module and transaction processor interface via a network.

5. A system as in claim 1, wherein the integration processor communicates with the transaction processor using formats and protocols native to the transaction processor.

6. A system in claim 1, wherein the integration processor parses IM messages to determine the transaction information.

7. A system as in claim 1, wherein the integration processor is configured to the determine transaction information by comparing text from a received IM message with keywords stored in a database.

8. A system as in claim 1, wherein the transaction system is an e-commerce system accessible view the Web.

9. A system as in claim 1, wherein the integration processor is configured to encrypt some or all of the transaction information.

10. A system as in claim 1, further comprising:
B. a transaction processor configured for processing transaction payments.

11. A system as in claim 1, wherein the integration module is further configured for generating transaction confirmations.

12. An instant messaging transaction integration system comprising a variety of devices configured to communicate over a variety of types of networks, the system comprising:
A. a user device configured to communicate using instant messaging (IM);
B. a transaction system configured to conduct a transaction using a set of transaction instructions and data and configured to generate a set of requests to obtain the set of transaction instructions and data; and
C. an integration module configured to generate IM messages configured for processing by the user device that solicit IM responses comprising transaction information useful in satisfying a set of requests by the transaction processor, the integration module also configured to generate from the IM responses user transaction instructions and data configured for processing by the transaction processor to satisfy the set of requests.

13. A system as in claim 12, wherein the transaction processor comprises one or more electronic reservation systems.

14. A system as in claim 12, wherein the integration module and transaction processor are integrated into a combined system.

15. A system as in claim 12, wherein the integration module and transaction processor interface via a network.

16. A system as in claim 12, wherein the integration processor communicates with the transaction processor using formats and protocols native to the transaction processor.

17. A system as in claim 12, wherein the integration processor parses IM messages to determine the transaction information.

18. A system as in claim 12, wherein the integration processor is configured to the determine transaction information by comparing text from a received IM message with keywords stored in a database.

19. A system as in claim 12, wherein the transaction system is an e-commerce system accessible view the Web.

20. A system as in claim 12, wherein the integration processor is configured to encrypt some or all of the transaction information.

21. A system as in claim 12, further comprising:
D. a transaction processor configured for processing transaction payments.

22. A system as in claim 12, wherein the integration module is further configured for generating transaction confirmations.

23. A method of conducting an electronic transaction using instant messaging (IM), the method comprising:
A. interfacing to a user device configured to communicate using IM;
B. interfacing to a transaction processor configured to conduct a transaction over a network in response to receipt of a set of transaction instructions and data and to generate a set of requests for the set of transaction instructions and data;
C. generating IM messages configured for processing by the user device that solicit IM responses comprising transaction information useful in satisfying a set of requests by the transaction processor; and
D. from the transaction information in the IM responses, generating user transaction instructions and data configured for processing by the transaction processor to satisfy the set of requests.

24. A method as in claim 23, wherein the transaction processor comprises one or more electronic reservation systems.

25. The method of claim 23, further comprising communicating with the transaction processor using formats and protocols native to the transaction processor.

26. The method of claim 23, further comprising parsing IM messages to determine the transaction information.

27. The method of claim 23, further comprising determining the transaction information by comparing text from a received IM message with keywords stored in a database.

28. The method of claim 23, wherein the transaction system is an e-commerce system accessible view the Web.

29. The method of claim 23, wherein the integration processor is configured to encrypt some or all of the transaction information.

30. The method of claim 23, further comprising processing transaction payments.

31. The method of claim 23, further comprising generating transaction confirmations.

32. A computer program product for conducting an electronic transaction using instant messaging (IM), the computer program product embodied on a program code configured to be stored on at least one storage media and executed by at least one processor, the program code comprising:
A. a program code configured for interfacing to a user device configured to communicate using IM;
B. a program code configured for interfacing to a transaction processor configured to conduct a transaction over a network in response to receipt of a set of transaction instructions and data and to generate a set of requests for the set of transaction instructions and data;
C. a program code configured for generating IM messages configured for processing by the user device that solicit IM responses comprising transaction information useful in satisfying a set of requests by the transaction processor; and
D. a program code configured for generating, from the transaction information in the IM responses, user transaction instructions and data configured for processing by the transaction processor to satisfy the set of requests.

33. A computer program code as in claim 32 wherein the transaction processor is an electronic reservation system.

34. A computer program code as in claim 32 wherein the transaction processor is an e-commerce system accessible via the Web.

35. An instant messaging-transaction integration system configured to interface with at least one user device and at least one electronic reservation processor, the at least one user device configured to communicate using instant messaging (IM) and the at least one electronic reservation processor configured to conduct reservation-related transactions using a set of transaction instructions and data and to generate a set of requests to obtain the set of transaction instructions and data, the system comprising:
A. an integration module configured to generate IM messages configured for processing by the user device that solicit IM responses comprising transaction information useful in satisfying a set of requests by the transaction processor, the integration module also configured to generate from the IM responses and provide to the at least one electronic reservation system a set of user transaction instructions and data incorporating the transaction information, such transaction instructions and data formatted for processing by the electronic reservation processor to satisfy the set of requests.

36. The system of claim 35, wherein the transaction information includes one or more indicia of dates of travel, desired accommodations and flights and user travel preferences.

37. A method of conducting an electronic reservation transaction using instant messaging, the method comprising:
A. interfacing to a user device configured to communicate using instant messaging (IM);
B. interfacing to an electronic reservation processor configured to conduct an electronic reservation transaction over a network in response to receipt of a set of transaction instructions and data and to generate a set of requests for the set of transaction instructions and data;
C. generating IM messages configured for processing by the user device that solicit IM responses comprising transaction information useful in satisfying a set of requests by the electronic reservation processor; and
D. from the transaction information in the IM responses, generating user transaction instructions and data in a format configured for processing by the electronic reservation processor to satisfy the set of requests.

38. The method of claim 37, wherein the transaction information includes one or more indicia of dates of travel, desired accommodations and flights and user travel preferences.

39. The method of claim 37, further comprising incorporating into the IM messages lists of transaction options for user consideration.

40. The method of claim 37, further comprising processing transaction payments.

41. The method of claim 37, further comprising generating transaction confirmations.
